(19) United States
(12) Patent Application Publication
(10) Pub. No.: US 2026/0024383 A1
(43) Pub. Date: Jan. 22, 2026

(54) VEHICLE CABIN SOUND

(71) Applicant: McLaren Automotive Limited, Woking (GB)

(72) Inventor: Stephen Gordon David Tucker, Woking (GB)

(21) Appl. No.: 19/270,832

(22) Filed: Jul. 16, 2025

(30) Foreign Application Priority Data
Jul. 22, 2024 (GB) 2410701.3

(51) Int. Cl. G07C 5/02; B60L 50/60; H04S 7/00

(52) U.S. Cl. CPC G07C 5/02; B60L 50/60; H04S 7/303; H04R 2499/13

(57) ABSTRACT

A method for delivering audible feedback to a driver within a cabin of a road vehicle, the vehicle comprising a plurality of wheels and an electric motor, the method comprising determining the torque delivered to at least two wheels of the plurality of wheels; determining a wheel torque distribution for the vehicle based on the determined torques; determining a primary sound location in the sound space in accordance with the wheel torque distribution; and inputting the primary sound location to a spatial audio system, the spatial audio system providing the audible feedback to the vehicle cabin such that the audible feedback is perceived by the driver to be originating from a virtual audio source at the primary sound location.

### CROSS-REFERENCE TO RELATED APPLICATION

This application claims priority to United Kingdom Patent Application No. 2410701.3, entitled “Vehicle Cabin Sound,” filed Jul. 22, 2024, which is hereby incorporated by reference.

### TECHNICAL FIELD

This invention relates to delivery of sound to the cabin of a vehicle.

### BACKGROUND

In vehicles which are driven using a traditional internal combustion engine, sounds are generated by the engine, which provide the driver with audible feedback about the behaviour of the engine while the vehicle is being driven, thereby aiding the driver with controlling the vehicle. With the development of electric and hybrid vehicles which commonly emit very little sound whilst being driven, techniques have been developed for generating artificial sound and delivering that sound to the vehicle cabin so that it can be heard by a driver of the vehicle. Artificial sounds can be generated to replicate the sound of a traditional vehicle engine. Artificial engine noise can be delivered to the vehicle cabin to provide audible feedback to the driver about the engine performance.

The inventors of the present invention have discovered that it is desirable to deliver audible feedback to the driver which provides the driver with additional information about the behaviour of the vehicle. This information may be indicative of certain movement patterns of the vehicle, for example, braking, acceleration and/or cornering. Providing this feedback to the driver can therefore advantageously assist the driver with vehicle handling.

It is therefore desirable to develop an electric or hybrid vehicle which can deliver sound to the vehicle cabin in order to provide the driver of the vehicle with audible feedback about the behaviour of the vehicle.

### SUMMARY OF THE INVENTION

There is provided a method for delivering audible feedback to a driver within a cabin of a road vehicle, the vehicle comprising a plurality of wheels and an electric motor coupled to at least one of the plurality of wheels and configured to drive the at least one of the plurality of wheels, the cabin housing a sound space comprising a network of sound locations, the method comprising determining the torque delivered to at least two wheels of the plurality of wheels; determining a wheel torque distribution for the vehicle based on the determined torques; determining a primary sound location in the sound space in accordance with the wheel torque distribution; and inputting the primary sound location to a spatial audio system, the spatial audio system being configured to deliver the audible feedback to the vehicle cabin such that the audible feedback is perceived by the driver to be originating from a virtual audio source located at the primary sound location.

The vehicle may have a longitudinal axis, the at least two wheels of the plurality of wheels may comprise a first wheel located on a first side of the longitudinal axis and a second wheel located on the opposite side of the longitudinal axis and the wheel torque distribution may represent a latitudinal wheel torque distribution for the vehicle.

In response to determining a latitudinal torque distribution which indicates that the same amount of torque is delivered to the first wheel and the second wheel, the primary sound location may be determined to be at a location equidistant from the first wheel and the second wheel.

In response to determining a latitudinal torque distribution which indicates that a greater torque is delivered to the first wheel than to the second wheel, the primary sound location may be determined to be at a location that is closer to the first wheel than to the second wheel.

The vehicle may have a longitudinal axis, the at least two wheels of the plurality of wheels may comprise a third wheel and a fourth wheel, the third wheel and the fourth wheel being located on the same side of the longitudinal axis, and the wheel torque distribution may represent a longitudinal wheel torque distribution for the vehicle.

In response to determining a longitudinal torque distribution which indicates that the same amount of torque is delivered at the third wheel and the fourth wheel, the primary sound location may be determined to be at a location equidistant from the third wheel and the fourth wheel.

In response to determining a longitudinal torque distribution which indicates that a greater torque is delivered to the third wheel than to the fourth wheel, the primary sound location may be determined to be at a location that is closer to the third wheel than to the fourth wheel.

The vehicle may have a longitudinal axis, the vehicle may comprise a plurality of wheels located on a first side of the longitudinal axis and a plurality of wheels located on the opposite side of the longitudinal axis, the torque delivered to each of the plurality of wheels may be determined, and the wheel torque distribution may represent a latitudinal and longitudinal torque distribution for the vehicle.

The vehicle may comprise four wheels: a front left wheel, a front right wheel, a rear left wheel and a rear right wheel and determining the torque delivered to at least two wheels may comprise determining the torque delivered to all four wheels.

The vehicle may have a longitudinal axis, and the sound space may comprise a first dimension perpendicular to the longitudinal axis of the vehicle and a second dimension parallel to the longitudinal axis of the vehicle.

The sound space may have an origin located at the intersection between a first line equidistant from the front and rear wheels and a second line equidistant from the left and right wheels, the origin having a first coordinate (x₀) indicating its position in the first dimension and a second coordinate (y₀) indicating its position in the second dimension.

Determining the primary sound location may comprise calculating a set of coordinates for the primary sound location within the sound space, a first coordinate (x) of the set indicating the position of the primary sound location in the first dimension and a second coordinate (y) of the set indicating the position of the primary sound location in the second dimension.

The first and second coordinates for the primary sound location may be determined based on one or both of the longitudinal wheel torque distribution and the latitudinal wheel torque distribution.

The wheel torque distribution for the vehicle may be a normalised wheel torque distribution comprising a normalised wheel torque for the front left wheel (|M_{fl}|), a normalised wheel torque for the front right wheel (|M_{fr}|), a normalised wheel torque for the rear left wheel (|Mᵣₗ|) and a normalised wheel torque for the rear right wheel (|Mᵣᵣ|).

The first coordinate for the primary sound location (x) may be determined in dependence on the latitudinal wheel torque distribution, the latitudinal wheel torque distribution being calculated using |M_{fr}|+|Mᵣᵣ|−|M_{fl}|−|Mᵣₗ|.

The second coordinate for the primary sound location (y) may be determined in dependence on the longitudinal wheel torque distribution, the longitudinal wheel torque distribution being calculated using |M_{fl}|+|M_{fr}|−|Mᵣₗ|−|Mᵣᵣ|.

Determining the set of coordinates for the primary sound location (x,y) may comprise determining a first offset in the first dimension of the primary sound location from the origin (x₀, y₀) and a second offset in the second dimension of the primary sound location from the origin (x₀, y₀), wherein the first offset of the primary sound location is determined as a product of |M_{fr}|+|Mᵣᵣ|−|M_{fl}|−|Mᵣₗ| and a constant kₓ and the second offset of the primary sound location is determined as a product of |M_{fl}|+|M_{fr}|−|Mᵣₗ|−|Mᵣᵣ| and a constant k_{y}.

The first coordinate of the primary sound location (x) may be calculated using a sum of the first offset and the first coordinate of the origin (x₀) and the second coordinate of the primary sound location (y) may be calculated using a sum of the second offset and the second coordinate of the origin (y₀).

The set of coordinates (x,y) for the primary sound location may be calculated using

$$x = {x}_{0} + {k}_{x} ( \vert {M}_{f r} \vert + \vert {M}_{r r} \vert - \vert {M}_{f l} \vert - \vert {M}_{r l} \vert )$$

$$y = {y}_{0} + {k}_{y} ( \vert {M}_{f l} \vert + \vert {M}_{f r} \vert - \vert {M}_{r l} \vert - \vert {M}_{r r} \vert )$$

where kₓ and k_{y} are constants.

The sound space may comprise a third dimension perpendicular to both the first dimension and the second dimension and the set of coordinates for the primary sound location may include a third coordinate indicating the position of the primary sound location in the third dimension.

The audible feedback may comprise artificially generated vehicle noise.

The method may comprise inputting to the spatial audio system, the location of the head of the driver.

The vehicle may comprise one or more sensors configured to dynamically track the location of the head of the driver.

The spatial audio system may comprise a plurality of speakers and a computing unit and the method may comprise inputting to the computing unit, the number and location of the plurality of speakers.

The audible feedback may comprise a plurality of sound elements, each sound element being mappable to a sound location in the sound space and delivering the audible feedback may comprise mapping each sound element of the plurality of sound elements to a respective sound location in the sound space.

Delivering a sound element of the audible feedback in accordance with the sound element's mapping to a sound location in the sound space may comprise delivering the sound element such that the sound element is perceived by the driver to be originating from a virtual audio source located at the respective sound location.

The spatial audio system may be configured to deliver the audible feedback such that it is perceived by the driver that the greatest number of sound elements are originating from a virtual audio source located at the primary sound location.

The primary sound location may be the sound location to which the greatest number of sound elements are mapped.

There is also provided a road vehicle comprising a plurality of wheels and an electric motor coupled to at least one of the plurality of wheels and configured to drive the at least one of the plurality of wheels; a vehicle cabin housing a sound space comprising a network of sound locations; a vehicle control unit; a feedback control unit; a spatial audio system, the vehicle control unit being configured to determine the torque delivered to at least two wheels of the plurality of wheels; and determine a wheel torque distribution for the vehicle based on the determined torques; the feedback control unit being configured to determine a primary sound location in the sound space in accordance with the wheel torque distribution; and input the primary sound location to the spatial audio system, the spatial audio system being configured to deliver the audible feedback to the vehicle cabin such that the audible feedback is perceived by the driver to be originating from a virtual audio source located at the primary sound location.

There is also provided a method for delivering audible feedback to a driver within a cabin of a road vehicle, the cabin housing a sound space comprising a network of sound locations, the method comprising determining an acceleration of the road vehicle; determining a primary sound location in the sound space in accordance with the determined acceleration; and inputting the primary sound location to a spatial audio system, the spatial audio system being configured to deliver the audible feedback to the vehicle cabin such that the audible feedback is perceived by the driver to be originating from a virtual audio source located at the primary sound location.

The road vehicle may comprise a plurality of wheels and an electric motor coupled to at least one of the plurality of wheels and configured to drive the at least one of the plurality of wheels.

The vehicle may have a longitudinal axis, and the plurality of wheels may comprise a first wheel located on a first side of the longitudinal axis and a second wheel located on the opposite side of the longitudinal axis.

The vehicle may have a longitudinal axis, and the plurality of wheels may comprise a third wheel and a fourth wheel, the third wheel and the fourth wheel being located on the same side of the longitudinal axis.

The vehicle may have a longitudinal axis, and the sound space may comprise a first dimension perpendicular to the longitudinal axis of the vehicle and a second dimension parallel to the longitudinal axis of the vehicle.

The vehicle may comprise four wheels: a front left wheel, a front right wheel, a rear left wheel and a rear right wheel

The sound space may have an origin located at the intersection between a first line equidistant from the front and rear wheels and a second line equidistant from the left and right wheels, the origin having a first coordinate (x₀) indicating its position in the first dimension and a second coordinate (y₀) indicating its position in the second dimension.

Determining the primary sound location may comprise calculating a set of coordinates for the primary sound location within the sound space, a first coordinate (x) of the set indicating the position of the primary sound location in the first dimension and a second coordinate (y) of the set indicating the position of the primary sound location in the second dimension.

The sound space may comprise a third dimension perpendicular to both the first dimension and the second dimension, and the set of coordinates for the primary sound location may include a third coordinate indicating the position of the primary sound location in the third dimension.

The audible feedback may comprise artificially generated vehicle noise.

The method may comprise inputting to the spatial audio system, the location of the head of the driver.

The vehicle may comprise one or more sensors configured to dynamically track the location of the head of the driver.

The spatial audio system may comprise a plurality of speakers and a computing unit and the method may comprise inputting to the computing unit, the number and location of the plurality of speakers.

The audible feedback may comprise a plurality of sound elements, each sound element being mappable to a sound location in the sound space, and delivering the audible feedback may comprise mapping each sound element of the plurality of sound elements to a respective sound location in the sound space.

Delivering a sound element of the audible feedback in accordance with the sound element's mapping to a sound location in the sound space may comprise delivering the sound element such that the sound element is perceived by the driver to be originating from a virtual audio source located at the respective sound location.

The spatial audio system may be configured to deliver the audible feedback such that it is perceived by the driver that the greatest number of sound elements are originating from a virtual audio source located at the primary sound location.

The primary sound location may be the sound location to which the greatest number of sound elements are mapped.

Determining an acceleration of the road vehicle may comprise determining that the torque delivered to at least one wheel of the plurality of wheels has increased.

Determining an acceleration of the road vehicle may comprise determining that the torque delivered to all of the wheels of the plurality of wheels has increased.

Determining an acceleration of the road vehicle may comprise determining that the torque delivered to all of the wheels of the plurality of wheels has increased by the same amount.

Determining a deceleration (or negative acceleration) of the road vehicle may comprise determining that the torque delivered to all of the wheels of the plurality of wheels has decreased.

Determining a primary sound location in the sound space in accordance with the determined acceleration may comprise determining a third coordinate indicating the position of the primary sound location in the third dimension.

The third coordinate of the primary sound location may be indicative of the speed of the vehicle.

The third coordinate of the primary sound location may be varied in dependence on the speed of the vehicle.

The third coordinate of the primary sound location may be determined to be smaller when the vehicle is travelling at a lower speed than the third coordinate of the primary sound location which is determined when the vehicle is travelling at a higher speed.

The third coordinate of the primary sound location may be determined so as to increase when the vehicle is accelerating and to decrease when the vehicle is decelerating.

### BRIEF DESCRIPTION OF THE DRAWINGS

The embodiments are illustrated by way of example and not limitation in the accompanying drawings, in which like references in multiple drawings indicate like elements, and in which:

FIG. 1A shows a schematic drawing of a vehicle;

FIG. 1B shows a schematic drawing of a vehicle;

FIG. 2 shows a schematic drawing of a vehicle;

FIG. 3 shows a sound space within a vehicle;

FIG. 4 shows a method for delivering audible feedback;

FIG. 5 shows torques exerted at the wheels of a vehicle and an associated primary sound location;

FIG. 6 shows torques exerted at the wheels of a vehicle and an associated primary sound location;

FIG. 7 shows torques exerted at the wheels of a vehicle and an associated primary sound location; and

FIG. 8 shows torques exerted at the wheels of a vehicle and an associated primary sound location.

### DETAILED DESCRIPTION OF THE DRAWINGS

The following description is presented to enable any person skilled in the art to make and use the invention and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown but is to be accorded the widest scope consistent with the principles and features disclosed herein.

As discussed, vehicles which are driven using a traditional internal combustion engine provide the driver with audible feedback relating to the performance of the engine. For example, the frequency or pitch of the sound being emitted by the engine can be heard by the driver in the cabin in the vehicle. The frequency or pitch of the engine noise may be used by the driver to inform certain vehicle control actions, such as changing gear.

Other noises generated by the drivetrain (for example due to the interaction between the engine and the vehicle wheels) may indicate to the driver which wheel or wheels are gripping the driving surface more firmly than other wheels. Sounds providing audible feedback about the vehicle wheels can be used by the driver when deciding how and when to initiate certain vehicle control actions, such as steering, braking and accelerating.

For example, when the vehicle is braking, the noise generated by the drivetrain may provide an indication to the driver that the front wheels are gripping the driving surface more strongly than the rear wheels. This information may inform the driver's decision about how much pressure should be applied to the brake pedal and the timing of when the brake pedal should be released.

Similarly, when turning a left-hand corner, drivetrain noise heard by the driver in the vehicle cabin may provide information to the driver about how strongly wheels are gripping the driving surface. The feedback may signal to the driver that the left vehicle wheels are gripping the driving surface more strongly than the right vehicle wheels. This information may inform the driver's decision about how much to steer and/or when and how much to accelerate.

In electric and hybrid vehicles, an electric motor is used to drive one or more of the vehicle's wheels. The present invention utilises spatial audio technology in order to replicate audible feedback for vehicles whose wheels are electrically driven. The inventors of the present invention have discovered that the location from which the driver perceives the audible feedback to be originating can be used to educate the driver about which wheels may be gripping the driving surface more firmly.

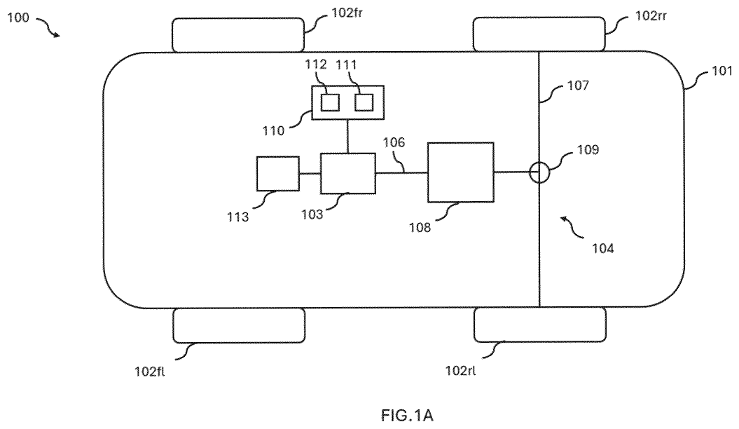

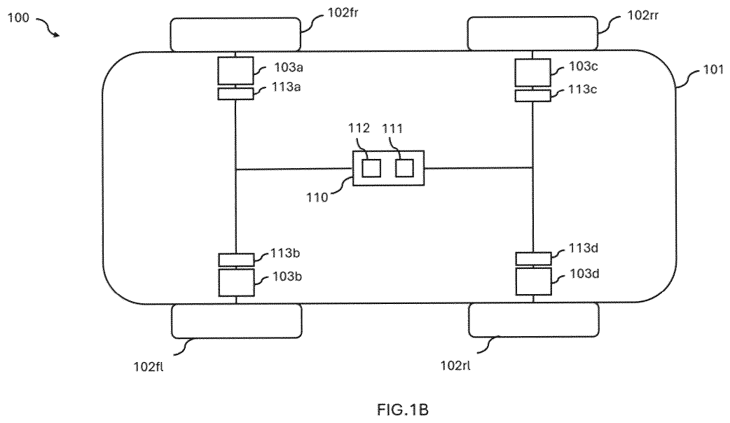

FIG. 1A illustrates a road vehicle 100. The vehicle 100 has a vehicle body 101. The vehicle 100 seen in FIG. 1A has four drive wheels 102. The vehicle comprises two front wheels and two rear wheels: a front left wheel 102fl, a front right wheel 102fr, a rear left wheel 102rl and a rear right wheel 102rr. At least one of those wheels is typically driven by a power source. The vehicle 100 seen in FIG. 1A is an electric vehicle and the power source is an electric motor 103. The electric motor 103 is coupled to a battery 113. In the example seen in FIG. 1A, the rear drive wheels 102rl, 102rr are coupled to the power source by a drivetrain 104. The drivetrain 104 includes a crankshaft 106 and a driveshaft 107. The drivetrain will generally comprise a gearbox 108 to permit the drive wheels 102 to be driven at a range of speeds greater than the standard speed range of the power source. The gearbox 108 couples the crankshaft 106 of the electric motor 103 to a driveshaft 107 for driving the wheels of the vehicle. The drivetrain may also comprise a differential 109 to split the drive originating from the power source to drive the two rear wheels 102rl, 102rr. In the electric vehicle 100 shown, the electric motor 103 and drive train 104 form part of a powertrain 105.

The operation of the electric motor 103 is regulated by a control unit 110. The control unit 110 comprises a processor 111 and a non-volatile memory 112. The ECU 110 may comprise more than one processor 111 and more than one memory 112. The memory 112 stores a set of program instructions that are executable by the processor, and reference data such as look-up tables that can be referenced by the processor in response to those instructions. The processor 111 may be configured to operate in accordance with a computer program stored in non-transitory form on a machine-readable storage medium. The computer program may store instructions for causing the processor to perform operations of the control unit. The control unit 110 may be a discrete unit or part of a more general vehicle control unit.

In the example seen in FIG. 1A, a single electric motor 103 is used to drive only the two rear wheels 102rl and 102rr via driveshaft 107 and the differential 109. In other vehicles, the motor may be used to drive only the two front wheels 102fl and 102fr. According to another example, one electric motor may be used to drive all four wheels. In this example, the vehicle may comprise a further drive shaft (a front drive shaft) and a front differential for connecting the front wheels to the electric motor. According to further examples, the power source may comprise more than one electric motor. For example, a first electric motor may be used to drive the front wheels, and a second electric motor may be used to drive the rear wheels.

According to a further example seen in FIG. 1B, the vehicle 100 may comprise four electric motors 103a, 103b, 103c, 103d, each configured to drive a single drive wheel. In other words, each drive wheel 102 may be driven by a dedicated electric motor for that wheel. In FIG. 1B, motor 103a is configured to drive wheel 102fr, motor 103b is configured to drive wheel 102f1, motor 103c is configured to drive wheel 102rr and motor 103d is configured to drive wheel 102rl. Each electric motor is coupled to the control unit 110. The control unit 110 may be configured to command each of the four electric motors to drive its respective wheel. In the example shown, each electric motor 103 is powered by a dedicated battery 113. Electric motor 103a is coupled to battery 113a, electric motor 103b is coupled to battery 113b, electric motor 103c is coupled to battery 113c and electric motor 103d is coupled to battery 113d. According to a different example, the vehicle may comprise fewer batteries, for example a single battery may be connected to and configured to provide power to all of the electric motors.

According to another example, the vehicle 100 is a hybrid vehicle in which the power source further includes an internal combustion engine (ICE). In a hybrid vehicle, the ICE is coupled to a fuel tank and an exhaust system that comprises a catalytic converter. The exhaust system is arranged to convey exhaust gases and residual combustion mixture from the internal combustion engine to a point exterior of the vehicle. In a hybrid vehicle, the ICE, electric motor and drive train form part of a powertrain.

As described, the vehicle 100 has four drive wheels, but it will be appreciated that according to different examples, the vehicle may comprise more or fewer wheels. For example, the vehicle may have 2, 6 or 8 drive wheels.

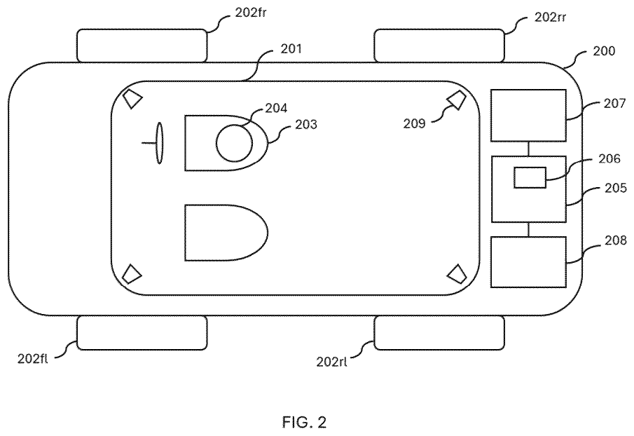

FIG. 2 shows a vehicle 200 having four wheels: a front left wheel 202fl, a front right wheel 202fr, a rear left wheel 202rl and a rear right wheel 202rr. In this example, vehicle 200 is an electric vehicle comprising an electric motor configured to drive all four wheels. As explained above, it will be appreciated that according to other examples, the vehicle may comprise more than one electric motor, for example four electric motors such that each wheel may be driven by a dedicated electric motor. The vehicle 200 has a vehicle cabin 201. The vehicle cabin is the internal region of the vehicle in which the driver and any passengers sit. The cabin 201 includes two vehicle seats. A driver 204 is seated in one of the seats 203.

As discussed, the present invention looks to provide audible feedback to the vehicle cabin so that it can be heard by the driver of the vehicle. The vehicle 200 comprises a spatial audio system 205. The spatial audio system comprises a computing unit 206. The audio system 205 further comprises a plurality of audio output devices such as speakers. The exemplary system 205 seen in FIG. 2 comprises four speakers 209 which are located in the four corners of the cabin. The audio system 205 may include any number of speakers. The speakers may be distributed in any arrangement within the vehicle cabin. The system may include speakers located in the ceiling and/or the floor of the vehicle. The spatial audio system 205 is configured to deliver an input sound to the vehicle cabin 201.

Spatial audio systems are used to create certain audio effects when delivering input sound to an environment. The input sound is made up of a plurality of sound elements. The environment to which sound is delivered may be associated with a sound space defined by a network of sound locations. Spatial audio systems are generally configured to deliver sound such that individual sound elements of the sound can be placed at particular locations within the sound space. Sound may be divided up into sound elements in a number of ways. For example, the sound may be divided up temporally such that sound elements represent a certain time period of the sound to be delivered. Alternatively, sound may be divided up according to frequency such that each sound element has a different pitch to the other sound elements. According to another example, sound may be divided up into sounds produced by a certain real or virtual instrument. In this example, each sound element may represent a sound produced by a single instrument. It will be appreciated that sound may be divided up into individual sound elements in a number of other different ways.

The sound elements of the input sound can be delivered by the spatial audio system so that they are placed at certain sound locations in the sound space in order to create a particular audio effect. For example, a spatial audio system can be used to create the audio effect that objects are moving e.g. from front to back, from floor to ceiling, and anywhere in between. For example, in a theatre setting where the theatre auditorium has an associated sound space, it may be desired to deliver the sound of a plane so that it sounds to the theatre audience that the plane is flying overhead. In this example, the spatial audio system would be configured to deliver the sound such that individual sound elements of the sound are placed at different sound locations along a line located above the theatre audience and output in a deliberate sequence (e.g. in a direction from the front to the back of the audience).

As will be explained in more detail below, the sound being input to the spatial audio system to be delivered by the spatial audio system, may be generated within the vehicle and be input to the spatial audio system. Alternatively, the sound may be generated elsewhere and stored in the vehicle in memory and input to the spatial audio system from that memory.

In order to achieve particular audio effects, it will be appreciated that, as well as the input sound that is to be delivered, the spatial audio system may require other information to be input into the system. This information includes the dimensions of the sound space and the number and location of speakers of the spatial audio system. Since the purpose of using a spatial audio system is to achieve a particular audio effect as perceived by the listener, the spatial audio system may also require information about the location of the listener, for example the location of the theatre audience within the sound space. The spatial audio system may also require an indication of the desired audio effect that is to be achieved when the sound is delivered. According to the present invention, as will be described in more detail below, the indication of the desired audio effect comprises the primary sound location which is the sound location in the sound space 301 from which the audible feedback should be perceived by the driver to be primarily originating, however the indication of the desired audio effect may take other forms.

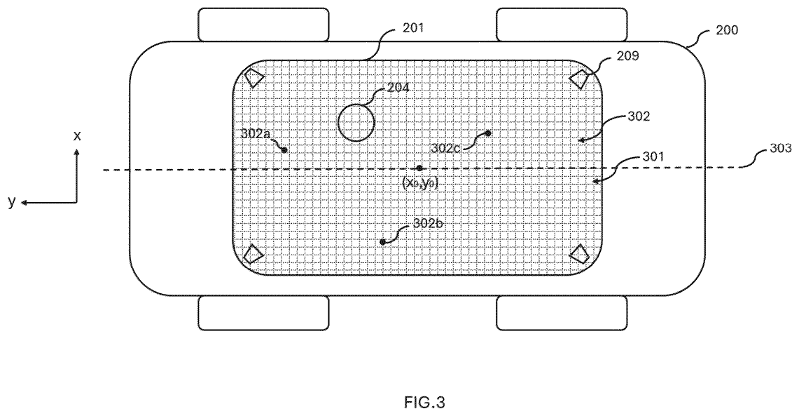

FIG. 3 illustrates a sound space 301 within the vehicle cabin 201 of vehicle 200. The vehicle has a longitudinal axis 303. The sound space 301 has an x dimension and a y dimension. The y dimension is parallel to the longitudinal axis 303 of the vehicle. The x dimension is perpendicular to the longitudinal axis 303 of the vehicle. As will be explained in more detail below, the sound space may also have a z dimension, the z dimension being perpendicular to both the x dimension and the y dimension. FIG. 3 illustrates a central point within the sound space 301, known as the origin. The origin is located at the intersection between a first line equidistant from the front and rear wheels and a second line equidistant from the left and right wheels (which coincides with the longitudinal axis 303 in FIG. 3). The origin has coordinates (x₀, y₀).

This figure shows that the sound space 301 is formed of a network of sound locations 302. The network in this example is a grid. FIG. 3 shows sound locations 302a, 302b, 302c. One or more sound elements may be mapped to each of these sound locations.

According to one example, the spatial audio system 205 of the vehicle 200 is configured to deliver sound elements so that they are perceived by the driver 204 as being emitted by a virtual audio source located at any sound location in the sound space, for example sound locations 302a, 302b and 302c. The computing unit 206 of the spatial audio system 205 is configured to determine how to output the sound from the speakers 209 such that sound elements are perceived by the driver 204 as being emitted by a virtual audio source located at sound locations 302a, 302b and 302c. The spatial audio system is configured to deliver the input sound so that it sounds to the driver that the sound elements originate from these locations even if the system does not include speakers positioned at those locations. The spatial audio system 205 may be a commercially available spatial audio system or a publicly known algorithm capable of generating 2D or 3D audio effects such as panning and ambisonics. As will be appreciated by the skilled person, the spatial audio system 205 may use vector base amplitude panning to determine how to deliver the sound such that the driver perceives sound elements to be located at sound locations 302a, 302b, 302c. As discussed, the computing system may use additional information including the size of the sound space 301, the number and locations of the speakers 209 and the position of the driver 204 to perform this determination.

The input to the computing system 206 about the position of the driver 204 may be a fixed position. For example, the approximate position of the driver's seat 203 within the vehicle cabin may be known. The position of the driver is thus known to be within the driver seat. More specifically, the position of the driver's head (and therefore ears) may be approximated using knowledge about the position of the driver's seat and average torso lengths. Alternatively, the input to the computing system 206 about the position of the driver 204 may be a dynamic position. The vehicle may include sensors, such as cameras, configured to dynamically determine the position and orientation of the driver's head. In this way, information about the position of the driver 204 being input to the computing system 206 of the spatial audio system 205 may be continuously updated as the driver moves.

The vehicle 200 may further comprise a sound generation unit 207 (seen in FIG. 2). The sound generation unit 207 is configured to generate artificial sounds, such as sounds relating to the vehicle. The sound generation unit 207 is configured to communicate with the spatial audio system 205 to deliver generated sounds to the spatial audio system. The spatial audio system 205 is configured to receive sounds from the sound generation unit 207 and output the sound at the speakers 209 so that the generated sounds can be heard by those present in the vehicle cabin. The generated sounds can be output by the spatial audio system 205 so as to act as audible feedback about the vehicle for the driver.

The sound generation unit 207 may be configured to generate sound which replicate sounds of a traditional drivetrain, for example engine noise. The sound generation unit 207 may be configured to generate sound imitating the interaction between vehicle wheels and the driving surface. The sound generation unit may be configured to generate other sounds which are commonly generated by an electric car, for example sounds replicating the noise made by an electric motor and other whooshing or whirring-type sounds. It will be appreciated that according to other examples, sounds are input to the spatial audio system 205 which are not generated by a sound generation unit 207 in the vehicle. For example, the vehicle may store in memory pre-loaded sound files which can be input to the spatial audio system.

As explained above, the spatial audio system may receive an indication of the desired audio effect that is to be achieved when the sound is delivered. As will be described in more detail below, the indication of the desired audio effect may include a primary sound location, which is the sound location in the sound space 301 from which the audible feedback should be perceived by the driver to be primarily originating. According to other examples, the indication of the desired audio effect may include further information, for example that the sound should be perceived to surround the listener, or a movement path of the sound e.g. that it moves from left to right, etc. The spatial audio system is configured to use the indication(s) to determine how to deliver the sound in a way that creates the desired audio effect (also taking into account the size of the sound space, the number and location of speakers and the location of the listener).

The inventors of the present invention have discovered that the location from which the driver perceives the audible feedback to be originating can be used to educate the driver about certain behaviours of the vehicle being driven, for example which wheels may be gripping the driving surface more strongly. This information can be utilised by the driver to inform decisions about how and when to initiate certain vehicle control actions such as steering, braking and accelerating.

FIG. 2 shows that the vehicle 200 further comprises an audible feedback control unit (FCU) 208. The FCU 208 is configured to determine at which location within the vehicle cabin (within the sound space 301) the audible feedback should be perceived by the driver 204 to be primarily originating from in order to give the driver useful information about the behaviour of the vehicle being driven. This location is referred to herein as the primary sound location. Information absorbed by the driver as a result of hearing this audible feedback will vary depending on where the driver perceives the sound to be originating i.e. where the primary sound location is. The FCU 208 is configured to calculate the primary sound location. In general terms, the FCU 208 determines this location depending on the torque being delivered to at least two wheels 202 of the vehicle. The primary sound location reflects the balance of torque being delivered to those wheels. The FCU 208 is coupled to the spatial audio system 205 and outputs the determined primary sound location to the spatial audio system in order that audible feedback is delivered to the vehicle cabin taking into account the primary sound location.

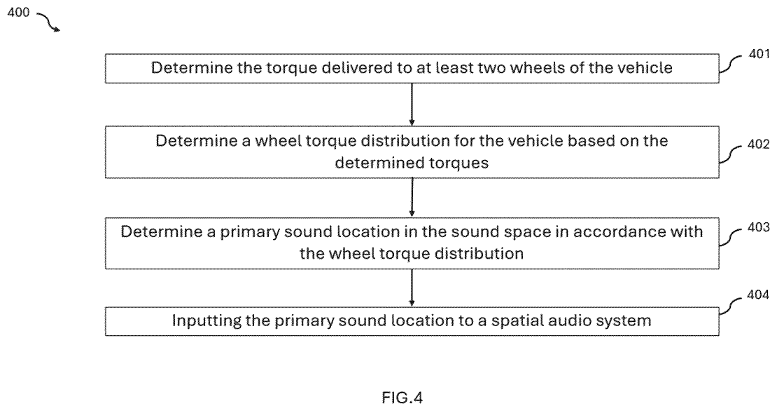

Specifically, the FCU 208 performs the method for delivering audible feedback seen in FIG. 4. The method comprises determining the torque delivered to at least two wheels of the vehicle (step 401), determining a wheel torque distribution for the vehicle based on the determined torques (step 402), determining a primary sound location in the sound space in accordance with the wheel torque distribution (step 403) and inputting the primary sound location to a spatial audio system (step 404).

At step 401, the 208 determines the torque delivered to at least two wheels of the vehicle. As mentioned, vehicle 200 is an electric vehicle comprising an electric motor configured to drive all four wheels. In this example, the FCU determines the torque delivered to all four of the vehicle's wheels. Determination of the torque delivered to each wheel may be performed by the control unit 110. It will be appreciated that there are a number of ways in which the torque delivered to the wheels may be determined.

According to an example previously described, the vehicle 200 has a single electric motor which drives each of the four wheels. The torque delivered to the rear wheels 202rl, 202rr may be determined by measuring the torque (e.g., using a torque sensor) at the rear drive shaft (e.g., 107 seen in FIG. 1A). The torque may be measured either side of the differential (109) to determine the torque delivered to the rear left wheel 202rl and the rear right wheel 202rr. The torque delivered to the front wheels 202fr, 202fl may be determined by measuring the torque at the front drive shaft. The torque may be measured either side of the front differential to determine the torque delivered to the front left wheel 202fl and the front right wheel 202fr.

According to another example, such as that seen in FIG. 1B, in which each wheel of a vehicle is driven by its own electric motor, each motor may be associated with a torque sensor. The torque at each wheel may therefore be determined as equal to the torque output by its respective electric motor, as determined by the torque sensor.

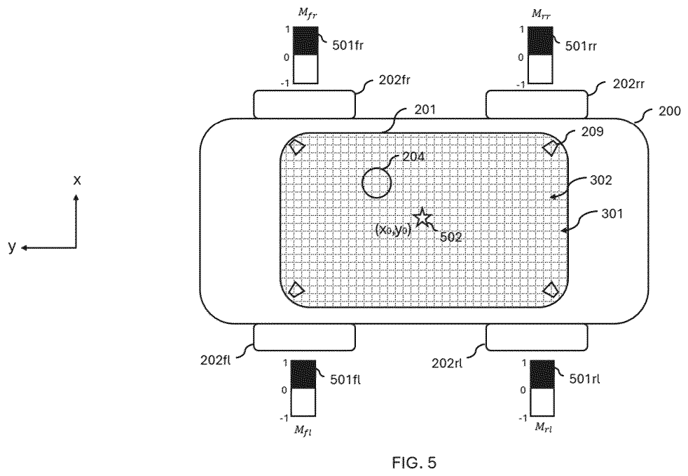

FIG. 5 illustrates torque representations 501fr, 501rr, 501fl and 501rl which illustrate the torque determined at the respective wheel and normalised to account for different ranges of torques available at each wheel. For example, the value of torque determined at each wheel may be divided by the maximum torque that can be experienced by that wheel. The torque at each wheel is therefore expressed as a proportion of the maximum torque available at that wheel in each direction. The result of normalising the torque at each wheel is that each wheel is associated with a torque value M between −1 and 1. In FIG. 5, the normalised torque at the front right wheel M_{fr} is illustrated by torque representation 501fr. The normalised torque at the front left wheel M_{fl} is illustrated by torque representation 501fl. The normalised torque at the rear left wheel Mᵣₗ is illustrated by torque representation 501rl. The normalised torque at the rear left wheel Mᵣᵣ is illustrated by torque representation 501rr.

A normalised torque value for a wheel of between 0 and 1 will be determined when that wheel is rotating forward with respect to the driving surface. A large positive value (e.g., between 0.5 and 1) will be determined when the wheel is gripping the driving surface strongly. A normalised torque value between −1 and 0 indicates that the wheel is resisting forward rotation e.g. when the vehicle is braking. A large negative value (e.g., between −0.5 and −1) will be determined when the wheel is resisting forward rotation strongly.

At step 402, the 208 determines a wheel torque distribution for the vehicle based on the determined torques. The wheel torque distribution may comprise an indication of the magnitude of torque delivered to each wheel of the vehicle. The wheel torque distribution may comprise the determined torque delivered to each wheel and the respective location of that wheel, thereby giving an indication of the wheel torques experienced across the vehicle.

The wheel torque distribution may be a latitudinal distribution, i.e., how the wheel torque is spread between the left and right sides of vehicle. In other words, the wheel torque distribution may be an indication that a greater torque is experienced by wheels on one side of the vehicle than those on the other side. The latitudinal distribution may be determined by finding the difference between the torques experienced by the right-hand wheels (103fr, 103rr) and the torques experienced by the left-hand wheels (103f1, 103rl). In other words, the latitudinal distribution may be determined using |M_{fr}|+|Mᵣᵣ|−|M_{fl}|−|Mᵣₗ|.

The wheel torque distribution may be a longitudinal distribution i.e. how the wheel torque is spread between the front and rear of the vehicle. The longitudinal distribution may be determined by finding the difference between the torques experienced by the front wheels (103f1, 103fr) and the torques experienced by the rear wheels (103rl, 103rr). In other words, the longitudinal distribution may be determined using |M_{fl}|+|M_{fr}|−|Mᵣₗ|−|Mᵣᵣ|.

The wheel torque distribution may be both a latitudinal and longitudinal distribution, i.e., how the wheel torque is spread between the left and right, and front and rear of the vehicle. The wheel torque distribution may be a normalised torque distribution.

FIG. 5 illustrates that the torque at each wheel is at a maximum value. In this example, the normalised torque M at each wheel is the same as the normalised torque at every other wheel: M_{fl}=M_{fr}=Mᵣₗ=Mᵣᵣ=1. The wheel torques are equally balanced. The wheel torque distribution may be calculated from the absolute values of normalised torques. The wheel torque distribution may represent the spread of normalised torques |M_{fl}|, |M_{fr}|, |Mᵣₗ| and |Mᵣᵣ| across the wheels of the vehicle.

Since in this example the torque is determined for all four wheels of the vehicle, a wheel torque distribution which is both latitudinal and longitudinal can be determined.

According to other examples, the wheel torque distribution could take other forms and may include less information. For example, the wheel torque distribution may be simply an indication that one or more of the vehicle wheels is experiencing a greater torque than the other wheels.

At step 403, the FCU 208 determines a primary sound location in accordance with the wheel torque distribution. In other words, the primary sound location is determined in dependence on the wheel torque distribution. Determining a primary sound location may comprise calculating the coordinates (x, y) of the primary sound location within the sound space.

The x coordinate indicates the position of the primary sound location in the x dimension, which is perpendicular to the vehicle's longitudinal axis. The y coordinate indicates the position of the primary sound location in the y dimension, which is parallel to the vehicle's longitudinal axis.

FIG. 5 illustrates a primary sound location 502. Because the wheel torques are evenly distributed in the example seen in FIG. 5, the primary sound location 502 is located at the origin of the sound space having coordinates (x₀, y₀). The primary sound location 502 therefore has coordinates (x₀, y₀) within the sound space. In other words, because the absolute value of normalised torque is distributed evenly between the four wheels, the primary sound location 502 is at the origin (x₀, y₀). The primary sound location may be equidistant from each of the four wheels.

The primary sound location is determined in dependence on the torque delivered to at least two wheels of the vehicle. The coordinates of the primary sound location may be calculated based on the normalised torque value for at least two wheels of the vehicle. For example, where a normalised torque value is determined for all four wheels of the vehicle (|M_{fl}|, |M_{fr}|, |Mᵣₗ| and |Mᵣᵣ|), the coordinates of the primary sound location may be calculated based on the normalised torque value determined at each wheel.

The primary sound location is determined in accordance with the wheel torque distribution. The coordinates of the primary sound location may be calculated in dependence on the spread of wheel torques experienced by the vehicle. As above, if the wheel torques are evenly distributed across the vehicle, the primary sound location may be determined to have a central position with respect to the vehicle cabin, such as at the origin of the sound space (x₀, y₀). The coordinates of the primary sound location may be calculated to have a position that is located between a central position with respect to the vehicle cabin and the wheel or wheels which are experiencing the greatest torque. For example, if a greater wheel torque is experienced by the left-hand wheels 103fl, 103rl than the right-hand wheels 103fr, 103rr, then the primary sound location may be determined to have a location on the left side of the vehicle cabin. If a greater wheel torque is experienced by the rear wheels 103rr, 103rl than the front wheels 103fr, 103fl, then the primary sound location may be determined to have a location in the rear half of the vehicle cabin.

The coordinates of the primary sound location may be determined based on one or both of the longitudinal wheel torque distribution and the latitudinal wheel torque distribution. The x coordinate of the primary sound location (x) may be determined in dependence on the spread of wheel torques experienced across the left and right sides of the vehicle. The x coordinate of the primary sound location (x) may be determined based on the latitudinal wheel torque distribution. The x coordinate of the primary sound location (x) may be determined based on the difference between the torque experienced at the right-hand wheels and the torque experienced at the left-hand wheels. The x coordinate of the primary sound location may be determined using the result of |M_{fr}|+|Mᵣᵣ|−|M_{fl}|−|Mᵣₗ|.

The y coordinate of the primary sound location may be determined in dependence on the spread of wheel torques experienced between the front and rear of the vehicle. The y coordinate of the primary sound location may be determined based on the longitudinal wheel torque distribution. The y coordinate of the primary sound location may be determined based on the difference between the torque experienced at the front wheels and the torque experienced at the rear wheels. The y coordinate of the primary sound location may be determined using the result of |M_{fl}|+|M_{fr}|−|Mᵣₗ|−|Mᵣᵣ|.

The offset of the primary sound location from a central position within the sound space (e.g., origin (x₀, y₀)) may be determined in accordance with the wheel torque distribution. The offset of the primary sound location from a central position within the sound space (e.g., origin (x₀, y₀)) may be determined based on one or both of the longitudinal wheel torque distribution and the latitudinal wheel torque distribution. The offset of the primary sound location from a central position within the sound space may be determined in dependence on the latitudinal wheel torque distribution. The offset of the x coordinate of the primary sound location in the x dimension from (x₀, y₀), herein referred to as the first offset, may be determined in dependence on |M_{fr}|+|Mᵣᵣ|−|M_{fl}|−|Mᵣₗ|. The first offset may be determined as product of |M_{fr}+|Mᵣᵣ|−|M_{fl}|−|Mᵣₗ| and a constant, kₓ. The constant kₓ may be associated with the size of the sound space in the x dimension. For example, the constant kₓ may be directly proportional to the size of the sound space in the x dimension. As such, for a sound space having a larger width (a larger size in the x dimension), the offset of the x coordinate of the primary sound location from x₀ will be greater than for a sound space having a smaller width. The x coordinate of the primary sound location may be calculated as a sum of the central position of the sound space x₀ and a product of |M_{fr}+|Mᵣᵣ|−|M_{fl}|−|Mᵣₗ| and the constant kₓ.

The offset of the primary sound location from a central position within the sound space may be determined in dependence on the longitudinal wheel torque distribution. In other words, the offset of the y coordinate of the primary sound location in the y dimension from (x₀, y₀), herein referred to as the second offset, may be determined in dependence on |M_{fl}|+|M_{fr}|−|Mᵣₗ|−|Mᵣᵣ|. The second offset may be determined as product of |M_{fl}|+|M_{fr}|−|Mᵣₗ|−|Mᵣᵣ| and a constant, k_{y}. The constant k_{y} may be associated with the size of the sound space in the y dimension. For example, the constant k_{y} may be directly proportional to the size of the sound space in the y dimension. As such, for a sound space having a larger length (a larger size in the y dimension), the offset of the y coordinate of the primary sound location from y₀ will be greater than for a sound space having a smaller length. The y coordinate of the primary sound location may be calculated as a sum of the central position of the sound space y₀ and a product of |M_{fl}|+|M_{fr}|−|Mᵣₗ|−|Mᵣᵣ| and the constant k_{y}.

The coordinates (x,y) of the primary sound location may be calculated using equation (1) and equation (2) below.

$$x = {x}_{0} + {k}_{x} ( \vert {M}_{f r} \vert + \vert {M}_{r r} \vert - \vert {M}_{f l} \vert - \vert {M}_{r l} \vert ) \qquad ( equation 1 )$$

$$y = {y}_{0} + {k}_{y} ( \vert {M}_{f l} \vert + \vert {M}_{f r} \vert - \vert {M}_{r l} \vert - \vert {M}_{r r} \vert ) \qquad ( equation 2 )$$

Where:
x is the x coordinate of the primary sound location
x₀ is the x coordinate of the origin of the sound space
y is the y coordinate of the primary sound location
y₀ is the y coordinate of the origin of the sound space
   |M_{fr}| is the absolute normalised torque value at the front right wheel 202fr
   |Mᵣᵣ| is the absolute normalised torque value at the rear right wheel 202rr
   |M_{fl}| is the absolute normalised torque value at the front left wheel 202fl
   |Mᵣₗ| is the absolute normalised torque value at the rear left wheel 202rl
kₓ is a constant
k_{y} is a constant

kₓ may be a constant associated with the size of the sound space in the x dimension. For example, kₓ may have a value that is directly proportional to the size of the sound space in the x dimension. k_{y} may be a constant associated with the size of the sound space in the y dimension. For example, k_{y} may have a value that is directly proportional to the size of the sound space in the y dimension

Applying equations (1) and (2) to the example torque distribution seen in FIG. 5, since the absolute normalised torque value for each wheel is equal to 1 and is equal to that of every other wheel, equations (1) and (2) simplify to:

$$x = {x}_{0}$$

$$y = {y}_{0}$$

Thus, the coordinates of the primary sound location 502 are calculated as (x₀, y₀) meaning that the primary sound location 502 is at the origin of the sound space 301.

At step 404, the FCU 208 inputs the primary sound location to the spatial audio system 205. The spatial audio system 205 is configured to deliver the audible feedback such that the audible feedback is perceived by the driver to be originating from a virtual audio source located at the primary sound location.

As explained above, the spatial audio system may require a number of inputs to be able to output the desired audible feedback to create the desired audio effect. The inputs include an indication of the desired audio effect. According to this example, the primary sound location is input to the spatial audio system as an indication of the desired audio effect. In the example of FIG. 5, the desired audio effect is that the audible feedback sounds to the driver as though it is being emitted by a virtual audio source located at the origin of the sound space. In other words, that the audible feedback is being emitting from a central location within the vehicle cabin and is not associated with any particular vehicle wheel.

As previously explained, the audible feedback to be delivered comprises a plurality of sound elements. The FCU 208 may be coupled to the computing system 206 of the spatial audio system 205 directly and may be configured to input the determined primary sound location to the computing system 206. Once the spatial audio system has received the required inputs, so as to deliver the audible feedback such that is perceived to be originating from the primary sound location, the spatial audio system 205 may map each sound element of the plurality of sound elements in the audible feedback to a respective sound location in the sound space 301. The spatial audio system 256 may deliver each sound element such that it is perceived by the driver to be originating from a virtual audio source located at the respective sound location. The cumulative effect of delivering each sound element in this way may be that the audible feedback sounds to the driver as though it is originating from a virtual audio source located at the primary sound location. According to the present example, this process may involve mapping all or a large number of the sound elements of the audible feedback onto the primary sound location The primary sound location may be the sound location of the sound space to which the greatest number of sound elements are mapped. According to another example, the sound elements are mapped to a plurality of sound locations which are centred around the primary sound location.

The spatial audio system 205 is configured to then determine how best to output the audible feedback from the speakers 209 so that it is perceived by the driver 204 to be primarily emitted from a virtual audio source located at the primary sound location thereby achieving the desired audio effect.

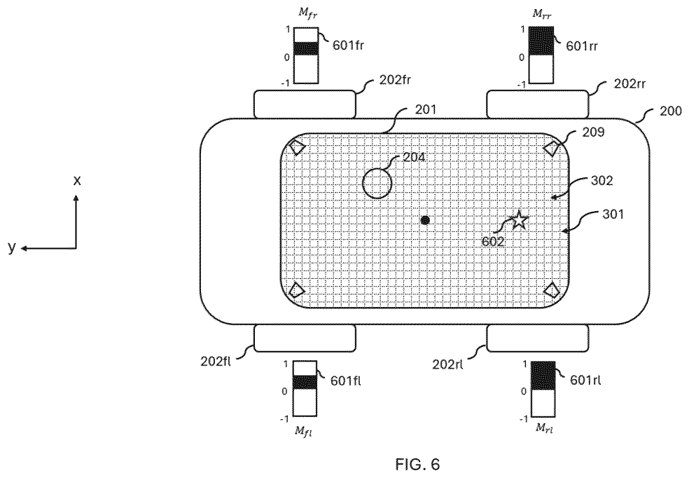

FIG. 6 illustrates the same vehicle in a different scenario in which the wheel torques are no longer balanced. In this example, the vehicle is experiencing a loss of front grip. Therefore a greater torque is measured at the back wheels 202rl and 202rr than at the front wheels 202fl and 202fr. Specifically, the normalised torque values measured at the back wheels are equal to 1 (Mᵣᵣ=Mᵣₗ=1). The normalised torque values measured at the front wheels are equal to 0.5 (M_{fr}=M_{fl}=0.5). As previously, the wheel torque distribution represents the spread of normalised torques |M_{fl}|, |M_{fr}|, |Mᵣₗ| and |Mᵣᵣ| across the wheels of the vehicle.

The normalised torque distribution therefore indicates that a greater torque has been measured at the two back wheels than at the two front wheels. FIG. 6 illustrates that (because the wheel torques are no longer balanced), the primary sound location 602 is no longer located at the origin of the sound space (at (x₀, y₀)).

The coordinates of the primary sound location 602 can be calculated using equations (1) and (2) as follows:

$$x = {x}_{0} + {k}_{x} ( \vert {M}_{f r} \vert + \vert {M}_{r r} \vert - \vert {M}_{f l} \vert - \vert {M}_{r l} \vert )$$

$$x = {x}_{0} + {k}_{x} ( 0.5 + 1 - 0.5 - 1 )$$

$$x = {x}_{0}$$

$$y = {y}_{0} + {k}_{y} ( \vert {M}_{f l} \vert + \vert {M}_{f r} \vert - \vert {M}_{r l} \vert - \vert {M}_{r r} \vert )$$

$$y = {y}_{0} + {k}_{y} ( 0.5 + 0.5 - 1 - 1 )$$

$$y = {y}_{0} - {k}_{y}$$

The coordinates of the primary sound location 602 are therefore (x₀,(y₀−k_{y})). In other words, the location of the primary sound location 602 is shifted away from the origin along the y axis in a direction towards the rear wheels.

Analogously to the example seen in FIG. 5, at step 404, the FCU 208 inputs the determined primary sound location 602 to the spatial audio system 205. The spatial audio system 205 is configured to determine how best to output the audible feedback from the speakers 209 so that it is perceived by the driver 204 to be primarily emitted from a virtual audio source located at the primary sound location 602 thereby achieving the desired audio effect. In this example, because the primary sound location is shifted away from the origin towards the rear wheels 202rl, 202rr, the audio effect may be that the driver perceives the sound to be originating from the rear wheels. From this audible feedback, the driver will therefore glean information about the behaviour of the vehicle, e.g., that the vehicle is experiencing a loss of front grip. This information may inform how the driver continues to control the vehicle. For example, in response to hearing this audible feedback, the driver may choose to decelerate to allow the vehicle to regain grip at its front wheels.

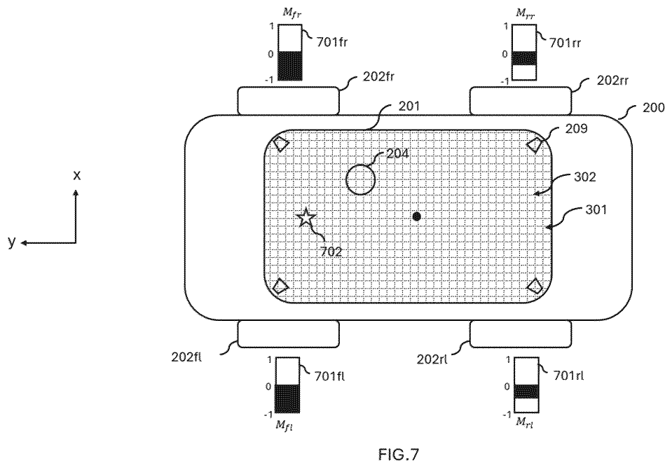

FIG. 7 illustrates the same vehicle in a further scenario in which the wheel torques are not equally balanced. In this example, the vehicle is braking. As such, each wheel is experiencing a negative torque. FIG. 7 illustrates that a greater negative torque is measured at the front wheels 202fl and 202fr than at the back wheels 202rl and 202rr. Specifically, the normalised torque values measured at the front left and front right wheels are equal to −1 (M_{fr}=M_{fl}=−1). The normalised torque values measured at the back left and back right wheels are equal to −0.5 (Mᵣᵣ=Mᵣₗ=−0.5).

As previously, the wheel torque distribution represents the spread of normalised torques |M_{fl}|, |M_{fr}|, |Mᵣₗ| and |Mᵣᵣ| across the wheels of the vehicle. Referring to the example seen in FIG. 7, in which the vehicle 200 is braking, the normalised torque distribution indicates that a greater torque has been measured at the two front wheels than at the two back wheels. FIG. 7 illustrates that (because the wheel torques are no longer balanced), the primary sound location 702 is not located at the origin of the sound space (at (x₀, y₀)).

The coordinates of the primary sound location 702 can be calculated using equations (1) and (2) as follows:

$$x = {x}_{0} + {k}_{x} ( \vert {M}_{f r} \vert + \vert {M}_{r r} \vert - \vert {M}_{f l} \vert - \vert {M}_{r l} \vert )$$

$$x = {x}_{0} + {k}_{x} ( 1 + 0.5 - 1 - 0.5 )$$

$$x = {x}_{0}$$

$$y = {y}_{0} + {k}_{y} ( \vert {M}_{f l} \vert + \vert {M}_{f r} \vert - \vert {M}_{r l} \vert - \vert {M}_{r r} \vert )$$

$$y = {y}_{0} + {k}_{y} ( 1 + 1 - 0.5 - 0.5 )$$

$$y = {y}_{0} - {k}_{y}$$

The coordinates of the primary sound location 702 are therefore (x₀,(y₀+k_{y})). In other words, the location of the primary sound location 702 is shifted away from the origin along the y axis in a direction towards the front wheels.

Analogously to the previous examples, at step 404, the FCU 208 inputs the determined primary sound location 702 to the spatial audio system 205. The spatial audio system 205 is configured to determine how best to output the audible feedback from the speakers 209 so that it is perceived by the driver 204 to be primarily emitted from a virtual audio source located at the primary sound location 702 thereby achieving the desired audio effect. In this example, because the primary sound location is shifted away from the origin towards the front wheels 202f1, 202fr, the audio effect may be that the driver perceives the sound to be originating from the front wheels. From this audible feedback, the driver will therefore glean information about the behaviour of the vehicle, e.g., that the vehicle is decelerating. This information may inform how the driver continues to control the vehicle. For example, in response to hearing this audible feedback, the driver may choose to increase or decrease pressure on the brake pedal.

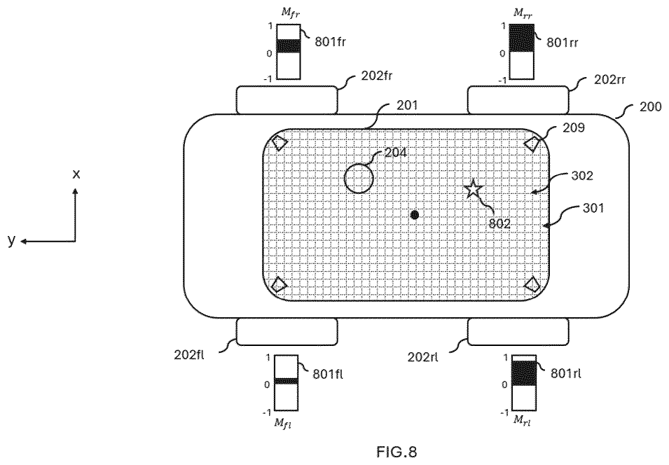

FIG. 8 illustrates the same vehicle in another scenario in which the wheel torques are no longer balanced. In this example, the vehicle is cornering. Specifically, the vehicle is exiting a left-hand corner. The rear right wheel 202rr is therefore experiencing the greatest amount of torque of the four wheels. The normalised torque at the rear right wheel 202rr is equal to 1 (Mᵣᵣ=1). The rear left wheel 202rl is also experiencing a large amount of torque, which is slightly less than that at the rear right wheel 202rr. The normalised torque at the rear left wheel 202rl is equal to 0.75 (Mᵣₗ=0.75). The front right wheel 202fr experiences half the amount of torque experienced at the rear right wheel 202rr. The normalised torque at the front right wheel 202fr is equal to 0.5 (M_{fr}=0.5). The front left wheel 202fl experiences the least amount of torque as the vehicle exits the left-hand corner. The normalised torque at the front left wheel 202fl is equal to 0.25 (M_{fl}=0.25).

As previously, the wheel torque distribution represents the spread of normalised torques |M_{fl}|, |M_{fr}|, |Mᵣₗ| and |Mᵣᵣ| across the wheels of the vehicle. The normalised torque distribution in this example indicates that the greatest torque is measured at the rear right wheel 202rr.

Performing step 403, the coordinates of the primary sound location 802 can be calculated using equations (1) and (2) as follows:

$$x = {x}_{0} + {k}_{x} ( \vert {M}_{f r} \vert + \vert {M}_{r r} \vert - \vert {M}_{f l} \vert - \vert {M}_{r l} \vert )$$

$$x = {x}_{0} + {k}_{x} ( 0.5 + 1 - 0.25 - 0.75 )$$

$$x = {x}_{0} + 0.5 {k}_{x}$$

$$y = {y}_{0} + {k}_{y} ( \vert {M}_{f l} \vert + \vert {M}_{f r} \vert - \vert {M}_{r l} \vert - \vert {M}_{r r} \vert )$$

$$y = {y}_{0} + {k}_{y} ( 0.25 + 0.5 - 0.75 - 1 )$$

$$y = {y}_{0} - {k}_{y}$$

The coordinates of the primary sound location 802 are therefore ((x₀+0.5kₓ),(y₀−k_{y})). The location of the primary sound location 802 is thus shifted away from the origin along the y axis in a direction towards the rear wheels and towards the right side of the vehicle. In other words, the primary sound location 802 is shifted towards the rear right wheel 202rr at which the greatest torque is experienced.

Analogously to the example seen in FIG. 5, at step 404, the FCU 208 inputs the determined primary sound location 802 to the spatial audio system 205. The spatial audio system 205 is configured to determine how best to output the audible feedback from the speakers 209 so that it is perceived by the driver 204 to be primarily emitted from a virtual audio source located at the primary sound location 802 thereby achieving the desired audio effect. In this example, because the primary sound location is shifted away from the origin towards the right rear wheel 202rr, the audio effect may be that the driver perceives the sound to be originating from the rear right wheel. From this audible feedback, the driver will therefore glean information about the behaviour of the vehicle, e.g., that the rear right wheel is gripping the driving surface a lot more than the other three wheels. This information may inform how the driver continues to control the vehicle. For example, in response to hearing this audible feedback, the driver may choose to change the steering angle and/or alter the speed of the vehicle.

The examples described thus far relate to a vehicle in which a single electric motor 103 drives four drive wheels 202, where a torque is measured at each of the four wheels and where the primary sound location can be varied within a two-dimensional sound space 301. The present techniques may be applied analogously to other types of vehicles.

For example, it will be appreciated that the same techniques can be adapted for vehicles with more than four wheels by adapting the form of equations (1) and (2). Similarly, an analogous method can be used for two vehicle wheels by using a one-dimensional sound space and shifting the position of the primary sound location only in one dimension in a direction between the two wheels. This approach may be applied to a two-wheeled vehicle or to only a subset of a vehicle's wheels. For example, the torque may be determined at only the front two wheels of a four-wheeled vehicle and the position of the primary sound location may be varied between those two wheels.

According to a further example, the techniques herein may be applied to groups, such as pairs, of a vehicle's wheels. For example, in a four-wheeled vehicle, the torque at the two front wheels and at the two rear wheels may be determined and may be used to determine a primary sound location between the front and rear pairs wheels. On other words, the location of the primary sound location can be varied in the longitudinal dimension only.

The description so far has focused on a two-dimensional sound space, for example a sound space having a single xy-plane. However, the methods described may be also adapted to three-dimensional sound spaces which have a z dimension, the z dimension being perpendicular to both the x dimension and the y dimension. The z dimension extends in a direction perpendicular to the ground on which the vehicle sits. In other words, the z dimension extends along the height of the vehicle.

The position of the primary sound location may be moved in the z dimension as well as the x and y dimensions as previously described. The set of coordinates for the primary sound location may therefore include a third coordinate indicating the position of the primary sound location in the third (z) dimension. The third coordinate (z) reflects the perceived “height” of the primary sound location within the sound space. Determining a primary sound location may thus comprise calculating three coordinates (x, y, z) of the primary sound location within the sound space. However, it will be appreciated that the position of the primary sound location may also be varied in only one or two dimensions of the three-dimensional sound space. For example, the position of the primary sound location may be varied only in the z dimension, or only in the xz-plane, etc.

In other words, the height of the primary sound location can be varied within the vehicle cabin. This implementation would be particularly compatible with spatial audio systems which include speakers located at different heights within the vehicle cabin, for example on the floor and on the ceiling. Altering the “height” of the primary sound location (its z coordinate) may change the audio effect that is achieved when the audible feedback is output by the spatial audio system. The perceived “height” of the primary sound location may be varied according to the wheel torque distribution. The z coordinate of the primary sound location may be determined based on the magnitude of torque being experienced at all of the plurality of wheels. The primary sound location may be determined in accordance with the acceleration or the speed of the vehicle. The acceleration of the vehicle may be determined using an accelerometer in the vehicle. For example, when the torque experienced at all of the plurality of wheels increases due to an acceleration of the vehicle, the z coordinate of the primary sound location may be increased. In other words, a uniform increase in torque across all of the wheels of the vehicle may be reflected in an increase to the perceived “height” of the primary sound location within the sound space. According to one example, an increase in vehicle speed may result in an increase to the perceived “height” of the sound being emitted by the spatial audio system. When the vehicle travels at a constant speed, the perceived “height” of the primary sound location may stay constant. The position of the primary sound location in the z dimension may be varied in dependence on the speed of the vehicle. The z coordinate of the primary sound location may be determined to be smaller when the vehicle is travelling at a lower speed, and the z coordinate of the primary sound location may be determined to be larger when the vehicle is travelling at a higher speed.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description, it will be evident to a person skilled in the art that various modifications may be made within the scope of the invention.

1. A method for delivering audible feedback to a driver within a cabin of a road vehicle, the road vehicle comprising a plurality of wheels and an electric motor coupled to at least one of the plurality of wheels and configured to drive the at least one of the plurality of wheels, the cabin housing a sound space comprising a network of sound locations, the method comprising:
determining a torque delivered to at least two wheels of the plurality of wheels;
determining a wheel torque distribution for the road vehicle based on the determined torques;
determining a primary sound location in the sound space in accordance with the wheel torque distribution; and
inputting the primary sound location to a spatial audio system, the spatial audio system being configured to deliver audible feedback to the vehicle cabin such that the audible feedback is perceived by the driver to be originating from a virtual audio source located at the primary sound location.

2. The method of claim 1, wherein the road vehicle has a longitudinal axis, the at least two wheels of the plurality of wheels comprise a first wheel located on a first side of the longitudinal axis and a second wheel located on the opposite side of the longitudinal axis, and the wheel torque distribution represents a latitudinal wheel torque distribution for the road vehicle.

3. The method of claim 2, wherein in response to determining the latitudinal wheel torque distribution which indicates that a same amount of torque is delivered to the first wheel and the second wheel, the primary sound location is determined to be at a location equidistant from the first wheel and the second wheel.

4. The method of claim 2, wherein, in response to determining the latitudinal wheel torque distribution which indicates that a greater torque is delivered to the first wheel than to the second wheel, the primary sound location is determined to be at a location that is closer to the first wheel than to the second wheel.

5. The method of claim 1, wherein the road vehicle has a longitudinal axis, the at least two wheels of the plurality of wheels comprise a third wheel and a fourth wheel, the third wheel and the fourth wheel being located on the same side of the longitudinal axis, and the wheel torque distribution represents a longitudinal wheel torque distribution for the road vehicle.

6. The method of claim 5, wherein, in response to determining a longitudinal torque distribution, which indicates that the same amount of torque is delivered at the third wheel and the fourth wheel, the primary sound location is determined to be at a location equidistant from the third wheel and the fourth wheel.

7. The method of claim 1, wherein, in response to determining a longitudinal torque distribution, which indicates that a greater torque is delivered to the third wheel than to the fourth wheel, the primary sound location is determined to be at a location that is closer to the third wheel than to the fourth wheel.

8. The method of claim 1, wherein the road vehicle has a longitudinal axis, the road vehicle comprises a plurality of wheels located on a first side of the longitudinal axis and a plurality of wheels located on the opposite side of the longitudinal axis, the torque delivered to each of the plurality of wheels is determined and the wheel torque distribution represents a latitudinal and longitudinal torque distribution for the road vehicle.

9. The method of claim 1, wherein the road vehicle comprises four wheels: a front left wheel, a front right wheel, a rear left wheel, and a rear right wheel, and determining the torque delivered to at least two wheels comprising determining the torque delivered to the four wheels.

10. The method of claim 1, wherein the road vehicle has a longitudinal axis, and the sound space comprises a first dimension perpendicular to the longitudinal axis of the road vehicle and a second dimension parallel to the longitudinal axis of the road vehicle.

11. The method of claim 10, wherein the sound space has an origin located at an intersection between a first line equidistant from the front and rear wheels and a second line equidistant from the left and right wheels, the origin having a first coordinate (x₀) indicating its position in the first dimension and a second coordinate (y₀) indicating its position in the second dimension.

12. The method of claim 10, wherein determining the primary sound location comprises calculating a set of coordinates for the primary sound location within the sound space, a first coordinate (x) of the set indicating the position of the primary sound location in the first dimension, and a second coordinate (y) of the set indicating the position of the primary sound location in the second dimension.

13. The method of claim 12, wherein the first and second coordinates for the primary sound location are determined based on one or both of the longitudinal wheel torque distribution and the latitudinal wheel torque distribution.

14. The method of claim 11, wherein the wheel torque distribution for the road vehicle is a normalised wheel torque distribution comprising a normalised wheel torque for the front left wheel (|M_{fl}|), a normalised wheel torque for the front right wheel (|M_{fr}|), a normalised wheel torque for the rear left wheel (|Mᵣₗ|) and a normalised wheel torque for the rear right wheel (|Mᵣᵣ|) and wherein determining the set of coordinates for the primary sound location (x,y) comprises determining a first offset in the first dimension of the primary sound location from the origin (x₀, y₀) and a second offset in the second dimension of the primary sound location from the origin (x₀, y₀), wherein the first offset of the primary sound location is determined as a product of |M_{fr}|+|Mᵣᵣ|−|M_{fl}|−|Mᵣₗ| and a constant kₓ and the second offset of the primary sound location is determined as a product of and a constant k_{y}.

15. The method of claim 12, wherein the sound space comprises a third dimension perpendicular to both the first dimension and the second dimension, and wherein the set of coordinates for the primary sound location include a third coordinate indicating the position of the primary sound location in the third dimension.

16. The method of claim 1, wherein the method comprises inputting to the spatial audio system the location of the head of the driver.

17. The method of claim 1, wherein the audible feedback comprises a plurality of sound elements, each sound element being mappable to a sound location in the sound space and delivering the audible feedback comprises mapping each sound element of the plurality of sound elements to a respective sound location in the sound space.

18. The method of claim 17, wherein delivering a sound element of the audible feedback in accordance with the sound element's mapping to the sound location in the sound space comprises delivering the sound element such that the sound element is perceived by the driver to be originating from a virtual audio source located at the respective sound location.

19. A road vehicle comprising:
a plurality of wheels and an electric motor coupled to at least one of the plurality of wheels and configured to drive the at least one of the plurality of wheels;
a vehicle cabin housing a sound space comprising a network of sound locations;
a vehicle control unit;
a feedback control unit;
a spatial audio system,
the vehicle control unit being configured to:
determine a torque delivered to at least two wheels of the plurality of wheels; and
determine a wheel torque distribution for the road vehicle based on the determined torques;
the feedback control unit being configured to:
determine a primary sound location in the sound space in accordance with the wheel torque distribution; and
input the primary sound location to the spatial audio system, the spatial audio system being configured to deliver the audible feedback to the vehicle cabin such that the audible feedback is perceived by a driver to be originating from a virtual audio source located at the primary sound location.

20. A method for delivering audible feedback to a driver within a cabin of a road vehicle, the cabin housing a sound space comprising a network of sound locations, the method comprising:
determining an acceleration of the road vehicle;
determining a primary sound location in the sound space in accordance with the determined acceleration; and
inputting the primary sound location to a spatial audio system, the spatial audio system being configured to deliver the audible feedback to the vehicle cabin such that the audible feedback is perceived by a driver to be originating from a virtual audio source located at the primary sound location.
